(19) United States
(12) Patent Application Publication
(10) Pub. No.: US 2018/0165261 A1
(43) Pub. Date: Jun. 14, 2018

(54) Method for synthesizing information useful for determining the effect of proposed legislation

(71) Applicant: Ian Gardner Mackenzie Hill, Northfield, NH (US)

(72) Inventor: Ian Gardner Mackenzie Hill, Northfield, NH (US)

(21) Appl. No.: 15/373,416

(22) Filed: Dec. 8, 2016

(51) Int. Cl. G06F 17/24; G06F 17/30; G06Q 50/18; G06Q 50/26

(52) U.S. Cl. CPC G06F 17/24; G06Q 50/26; G06Q 50/18; G06F 17/30696

(57) ABSTRACT

A method for synthesizing information useful for determining the effect of proposed legislation comprising the text of the proposed legislation, active law which the proposed legislation references or proposes to amend, and the definitions of terms defined in active law which appear in the text of the proposed legislation and related active law.

### BACKGROUND

Federal, state, and local legislators together propose thousands of bills a year, many of which are complex and reference or change many disparate sections of a particular legal code. Querying the official websites of state legislatures for a particular bill generally only returns the text of the bill without any other related information required to understand how the bill would affect the broader legal code. Simply displaying the proposed legislation satisfies laws requiring the government to publish legislative information but leaves a barrier for citizens wishing to understand the end effect of the proposed legislation. Particularly for citizens not employed in the practice of law, knowing the surrounding context and definitions of a piece of proposed legislation can be critical to understanding its ultimate effect.

### SUMMARY

One embodiment disclosed herein is a method for retrieving relevant active law as well as defined terms and definitions for a piece of proposed legislation. The method described herein provides citizens with context about a proposed changes to active law in order to illustrate the effect of those proposed changes.

One embodiment is a method comprising retrieving a first set of text using the processor of a first computer, the first set of text comprising a first set of data indicative of proposed changes to a first active law, and retrieving a second set of text using the processor of the first computer, the second set of text comprising data indicative of at least a portion of the first active law. The method also comprises selecting a subset of the second set of text using the processor of the first computer, the subset comprising defined terms and retrieving a third set of text using the processor of the first computer, the third set of text comprising data from the first active law indicative of definitions for the defined terms in the subset of the second set of text. The method further comprises outputting data indicative of a legislative text in which the processor of the first computer integrates the first, second, and third sets of text in a manner sufficient to simultaneously show the definitions for the defined terms and the first set of text on the screen of a second computer.

Another embodiment is a method comprising identifying and retrieving, using a computer processor, defined terms from data stored in a first computer memory or a second computer memory indicative of a first active law, identifying and retrieving, using the computer processor, the definitions of the defined terms from data stored in the first computer memory or the second computer memory indicative of the first active law, and organizing, using the computer processor, the defined terms and definitions into a data structure stored in the first computer memory or the second computer memory.

### BRIEF DESCRIPTION OF DRAWINGS

FIG. 1 shows a method for retrieving a bill, retrieving the set of relevant active law and referenced active law, and outputting those texts along with the appropriate defined terms.

FIG. 2 depicts a method for identifying and organizing defined terms and their definitions for later use in the method shown in FIG. 1.

FIG. 3 shows a non-limiting computer system on which the method in FIG. 1 and the method in FIG. 2 can be executed.

FIG. 4 is a reproduction of House Bill 1484 of the New Hampshire General Court from the 2016 legislative session.

FIG. 5 is a reproduction of Chapter 21-N, Section 10 of the New Hampshire Revised Statutes Annotated.

FIG. 6 is a reproduction of a portion of Chapter 653, Section 1 of the New Hampshire Revised Statutes Annotated.

FIG. 7 is a screenshot showing an exemplary display in accordance with one embodiment of a method disclosed herein.

### DETAILED DESCRIPTION

As used herein, the term “active law” refers to law which is in effect.

As used herein, the term “bill” means any piece of proposed legislation at any level of government including by not limited to legislation proposed in any national congress or parliament, any chamber of any state or provincial legislature, or any governing council or body of a county, municipal, or otherwise local government.

The embodiments described herein relate to a computerized method for retrieving and assembling data illustrative of the effect of a bill. Specifically, beyond accessing the text of a bill, the embodiments comprise retrieving the portions of active law which the bill references or proposes to amend and retrieving the definitions of specifically defined terms which can assist in revealing the effect of a bill and the referenced active law.

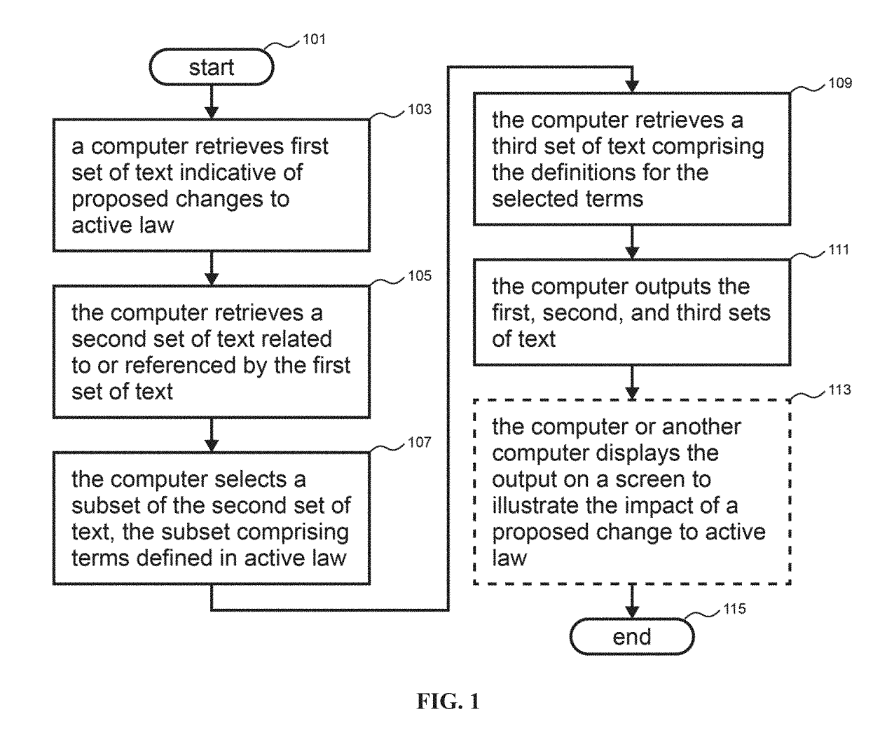

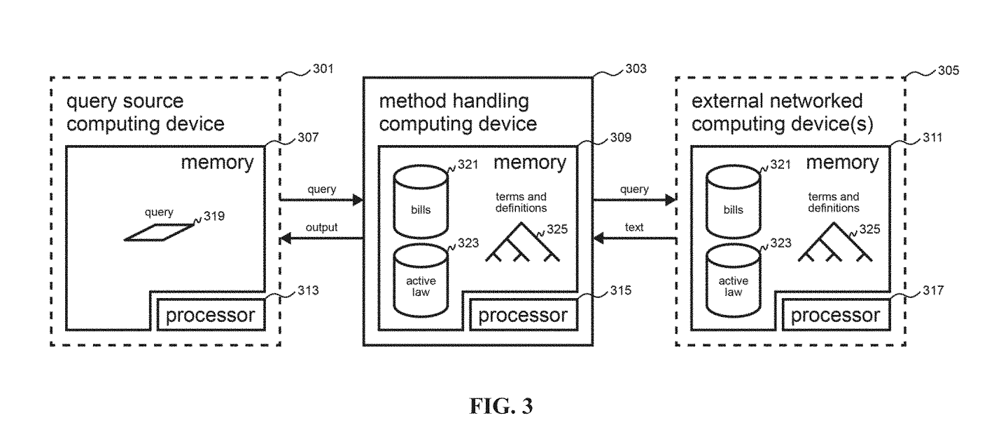

One embodiment comprises a method shown in FIG. 1 by which a computing device can query a database of proposed legislation, a database of active law, and a data structure of terms and definitions in order to assemble the information illustrative of the effect of a piece of proposed legislation. FIG. 3 shows a non-limiting computer system employed in executing the method in FIG. 1 comprising a computing device 303 handling the method, optionally a separate computing device 301 generating the query 319 networked to the method handling computing device 303, and optionally one or more external computing devices 305 networked to the method handling computing device 303.

In process block 103 of the method shown in FIG. 1, the method handling computing device 303 retrieves a bill from a database of bills 321 based on data contained within a query 319. The method handling computing device 303 receives the query 319 either from a separate computing device 301 on which the query 319 has been manually or programmatically generated within a processor 313 and stored memory 307 or manually or programmatically from the processor 315 of the method handling computing device 303 itself.

In block 105, the method handling computing device 303 retrieves the active law, from a database of active law 323, which the bill retrieved in block 103 references or proposes to amend. The retrieval executed as part of block 105 may require a set of rules specific to the database of bills 321 defining the format in which laws are referenced and where references can be found in bills contained within the specific database of bills 321. For an example of a format used to refer to particular portions of a legal code, “RSA 653:1, V” refers chapter 653, section 1, paragraph V in the New Hampshire Revised Statutes Annotated.

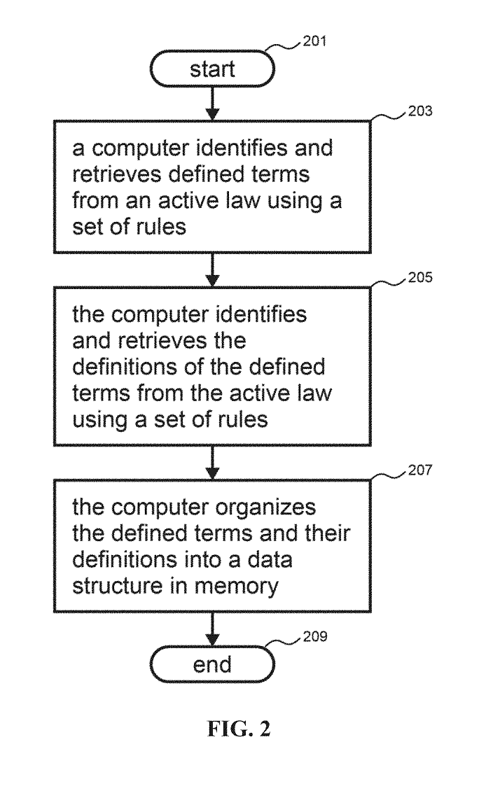

In block 107, the method handling computing device 303 selects the terms contained within the amended or referenced active law whose definitions are contained within the data structure of terms and definitions 325 generated using the method shown in FIG. 2 using the database of active law 323. Selecting the defined terms requires some logic to identify the defined terms from the surrounding text. The logic may be as simple as a keyword search or may be complex enough to consider the context surrounding each term.

In block 109, the method handling computing device 303 retrieves the definitions for the terms selected in block 107 from the data structure of terms and definitions 325.

In block 111, the method handling computing device 303 outputs the bill, the active law it references or proposes to amend, and the defined terms and definitions selected and defined in blocks 107 and 109 respectively. The output format depends on the application but, if the query were generated on an external query source computing device 301, may comprise a JSON object returned through a network connection to the query source computing device 301.

Optionally, in block 113, the method handling computing device 303 or another computing device displays the output on a screen in such a way as to illustrate the impact of the bill identified using the data contained within the query 319.

The database of bills 321, the database of active law 323, and data structure of defined terms and their respective definitions 325 can all either be accessed by the processor 315 from the memory 309 of the method handling computing device 303 or from the memory 311 of one or more external networked computing devices 305 where the local processor 317 would access the database 323 and return the requested text over a network connection to the processor 315 on the method handling computing device 303.

One embodiment of the method shown in FIG. 2 comprises generating the data structure of defined terms and their respective definitions used by block 107 and block 109 of the method shown in FIG. 1. A subset of FIG. 3 shows a non-limiting computer system employed in executing the method in FIG. 2 comprising a computing device 303 handling the method and optionally one or more external computing devices 305 networked to the method handling computing device 303.

In block 203 of FIG. 2, the processor 315 of the method handling computing device 303 identifies and retrieves terms defined a database of active law 323. Identification of the defined terms requires a set of rules describing what terms are defined in the database of active law.

In block 205, the processor 315 of the method handling computing device 303 identifies and retrieves the definitions of the terms identified in block 203 from the database of active law 323. Identification of the definitions of the defined terms requires a set of rules describing what constitutes the definition of a term defined in the active law.

For the execution of block 203 and block 205, the database of active law 323 is stored either in the memory 309 of the method handling computing device 303 or stored in the memory 311 of one or more external networked computing devices 305 and accessed remotely through a network connection.

Finally, in block 207, the processor 315 of the method handling computing device 303 organizes and stores the defined terms and definitions as a data structure in memory 309 for later use by the method shown in FIG. 1.

In one particular non-limiting embodiment, the method shown in FIG. 1 is implemented as part of a web based application where a user's personal computer serves as the query source computing device 301, a server hosting a web based application serves as the method-handling computing device 303, and a server of the New Hampshire General Court serves as an external networked computing device 305.

A database of active law 323, populated with the Revised Statutes Annotated of the State of New Hampshire, and a database of bills 321, populated with bills before the 2016 session of the New Hampshire General Court, are stored in the memory 311 of the external networked computing device 305 and can be accessed through a network connection by the method handling computing device 303.

Before the method described in FIG. 1 can be executed, the method described in FIG. 2 must be executed to generate the data structure of defined terms and definitions 325 used in block 107 and block 109 of the method described in FIG. 1.

First, the processor 315 of the web application server 303 accesses the server of the New Hampshire General Court to execute block 203 of the method described in FIG. 2. The web application server identifies and retrieves the terms defined in the database of the New Hampshire Revised Statutes Annotated 323 using a set of rules particular to that legal code describing what terms are defined.

The processor 315 of the web application server 303 then accesses the server of the New Hampshire General Court to execute block 205. The web application server identifies and retrieves the definitions of the terms identified in block 203 from the database of the New Hampshire Revised Statutes Annotated 323 using a set of rules particular to that legal code describing how and where the defined terms are defined.

Finally in block 207, the the processor 315 of the web application server 303 organizes the terms retrieved in block 203 and the definitions retrieved in block 205 into a data structure 325, namely a hashtable or dictionary, stored in memory 309.

The execution of the method described in FIG. 1 begins after the user queries the web application server for a particular bill. Say the user, from their personal computer 301, requests information for New Hampshire House Bill 1484 for the 2016 legislative session. The personal computer 301 may store the query in memory 307 for a moment, but ultimately, the processor 313 sends the query over a network connection to the web application server 303.

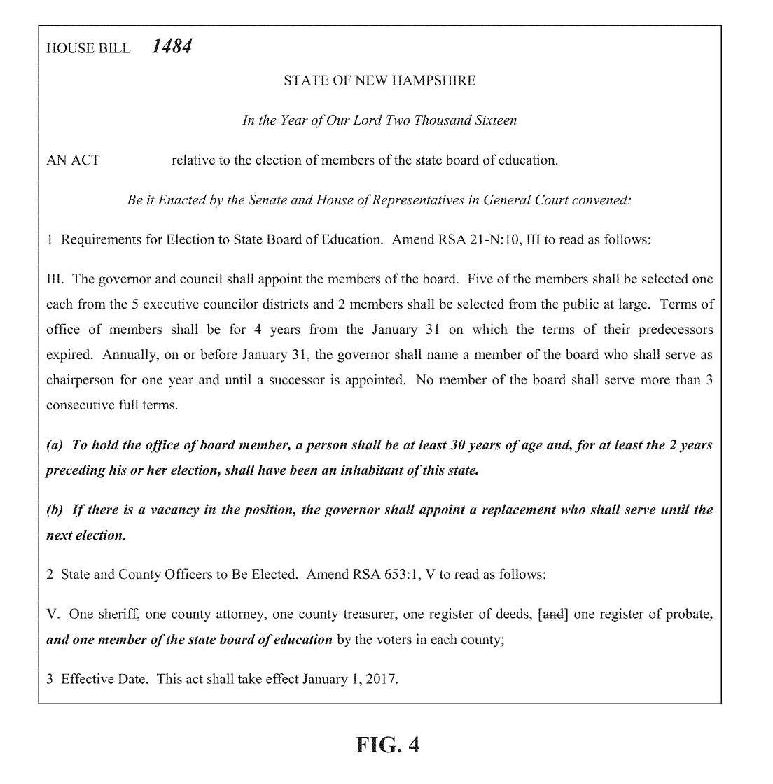

When the web application server 303 receives the query, the execution of the method described in FIG. 1 begins. In block 103 of the method in FIG. 1, The processor 309 of the web application server 303 communicates over a network connection with the processor 317 of the server of the New Hampshire General Court to retrieve H.B. 1484 shown in FIG. 4 from the database of bills stored in memory 311.

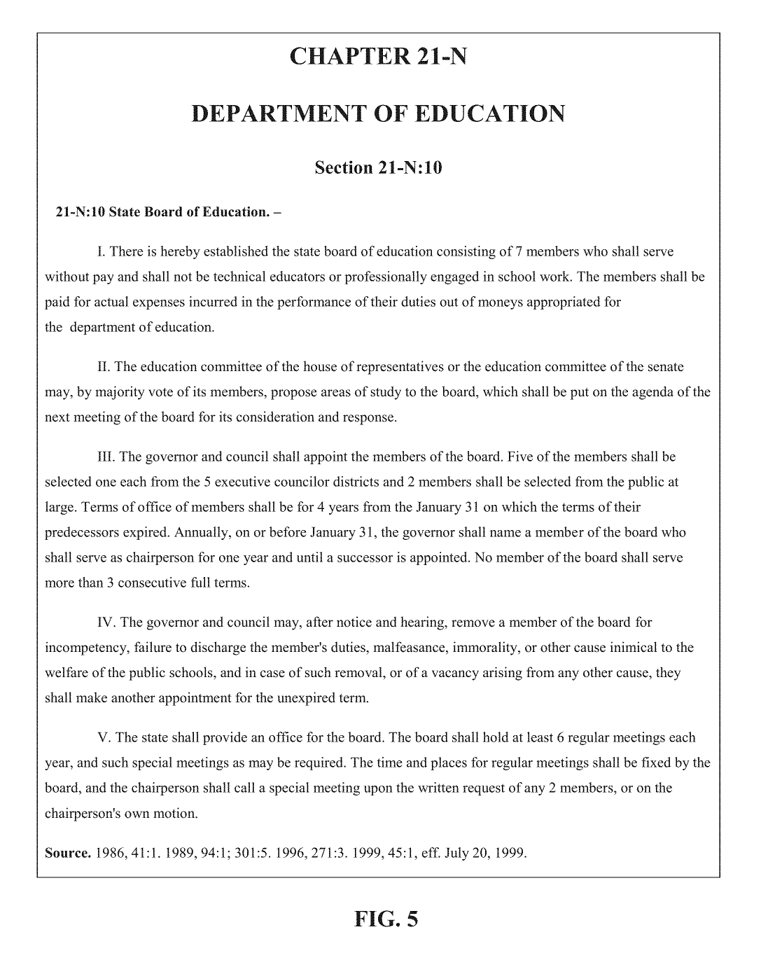

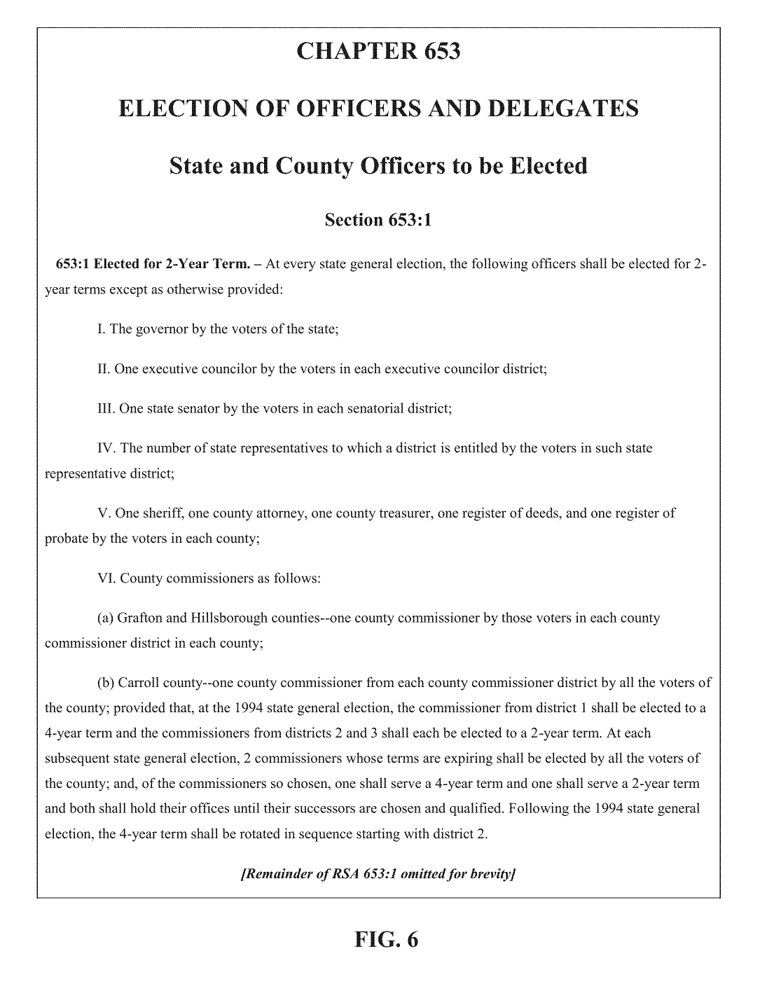

In block 105, the processor 315 of the web application server 303 uses a set of rules to determine that H.B. 1484, shown in FIG. 4, proposes to amend RSA 21-N:10, III and RSA 653:1, V. Having determined what sections of active law H.B. 1484 proposes to amend, the processor 315 of the web application server 303 communicates over a network connection with the processor 317 of the server of the New Hampshire General Court to retrieve RSA 21-N:10 and RSA 653:1, reproduced here in FIG. 5 and FIG. 6 respectively, from the database of bills stored in memory 311.

In block 107, the processor 315 of the web application server 303 uses the data structure of defined terms and definitions and logic specific to the New Hampshire Revised Statutes Annotated to select the defined terms used in H.B. 1484, RSA 21-N:10, and RSA 653:1.

In block 109, the processor 315 of the web application server 303 retrieves the definitions of the terms, selected in block 107, from the data structure of defined terms and definitions stored in memory 309 of the web application server 303.

In block 111, the processor 315 of the web application server 303 outputs from memory 309 the texts of H.B. 1484, RSA 21-N:10, and RSA 653:1 and the defined terms and their definitions used in H.B. 1484, RSA 21-N:10, and RSA 653:1. The processor 315 optionally communicates that output to the user's personal computer 301 where it can be simultaneously displayed on the screen for the user.

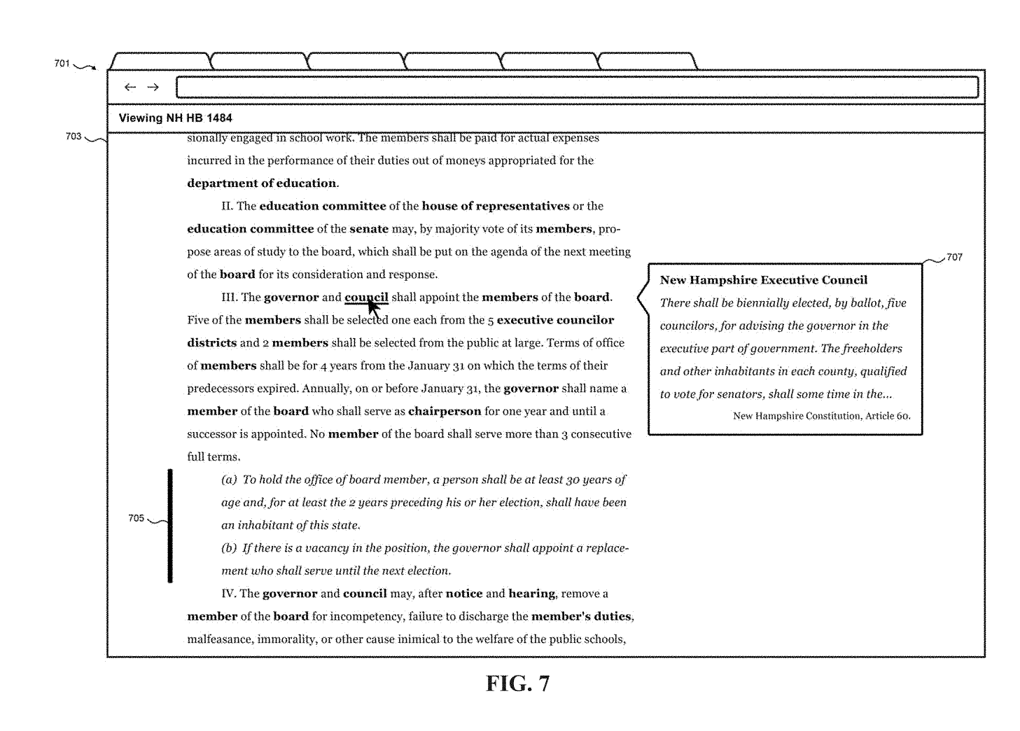

FIG. 7 shows an optional, non-limiting example 701 of a screen 703 showing a portion of RSA 21-N:10, the amendment 705 to RSA 21-N:10 proposed by H.B. 1484, and a portion of a definition 707 of the defined term “New Hampshire Executive Council.”

A number of alternatives, modifications, variations, or improvements therein may be subsequently made by those skilled in the art, which are also intended to be encompassed by the following claims.

What is claimed is:

1. A computerized method, comprising;
a. retrieving a first set of text using the processor of a first computer, the first set of text comprising a first set of data indicative of proposed changes to a first active law,
b. retrieving a second set of text using the processor of the first computer, the second set of text comprising data indicative of at least a portion of the first active law,
c. selecting a subset of the second set of text using the processor of the first computer, the subset comprising defined terms,
d. retrieving a third set of text using the processor of the first computer, the third set of text comprising data from the first active law indicative of definitions for the defined terms in the subset of the second set of text, and
e. outputting data indicative of a legislative text in which the processor of the first computer integrates the first, second, and third sets of text in a manner sufficient to simultaneously show the definitions for the defined terms and the first set of text on the screen of a second computer.

2. The method of claim 1, wherein the data comprising the output is simultaneously displayed on the screen of the second computer.

3. The method of claim 1, wherein the data being identified, retrieved, or selected by the computer processor is stored in the memory of the first computer.

4. The method of claim 1, wherein the data being identified, retrieved, or selected by the computer processor is stored in the memory of a third computer and accessed through a network connection by the computer processor.

5. A computerized method, comprising;
a. identifying and retrieving, using a computer processor, defined terms from data stored in a first computer memory or a second computer memory indicative of a first active law,
b. identifying and retrieving, using the computer processor, the definitions of the defined terms from data stored in the first computer memory or the second computer memory indicative of the first active law, and
c. organizing, using the computer processor, the defined terms and definitions into a data structure stored in the first computer memory or the second computer memory.

6. The method of claim 5, wherein the defined terms are identified using a set of rules specific to the data indicative of the first active law.

7. The method of claim 5, wherein the definitions of the defined terms are identified using a set of rules specific to the data indicative of the first active law.

8. The method of claim 5, wherein the data structure comprising the defined terms and the definitions of the defined terms can be accessed as part of other computerized methods.

9. The method of claim 5, wherein the data being identified, retrieved, or organized by the computer processor is stored in the first computer memory.

10. The method of claim 5, wherein the data being identified, retrieved, or organized by the computer processor is stored in the second computer memory.
